(19) United States
(12) Patent Application Publication
(10) Pub. No.: US 2009/0100023 A1
(43) Pub. Date: Apr. 16, 2009

(54) INFORMATION PROCESSING APPARATUS AND COMPUTER READABLE INFORMATION RECORDING MEDIUM

(76) Inventor: Koichi INOUE, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/248,468

(22) Filed: Oct. 9, 2008

(30) Foreign Application Priority Data
Oct. 11, 2007 (JP) NO. 2007-265655
Sep. 16, 2008 (JP) NO. 2008-237138

(51) Int. Cl. G06F 17/30; G06F 7/06

(52) U.S. Cl. 707/3; 707/100; 707/E17.014; 707/E17.044

(57) ABSTRACT

An information processing apparatus has a document element storing part configured to store a document in a document element storage part for each document element of the document, a comment input part configured to input a comment corresponding to the document element to a comment storing part, and the comment storing part configured to store the comment input by the comment input part corresponding to the document element in a comment storage part in such a manner that the comment is identified as the comment associated with the document element.

### BACKGROUND OF THE INVENTION

1. Field of the Invention

The present invention relates to an information processing apparatus for drawing image expression elements from a document, and managing them for the purpose that a plurality of users view the document in a sharing manner, and put comments or such to the document, and to a computer readable information recording medium storing a program for a computer to realize the above-mentioned functions of the information processing apparatus.

2. Description of the Related Art

For the purpose that a plurality of users can share a document, various methods may be used. For example, in one method, electronic mails are used to deliver the document to the users. In another method, a file is placed in a file server, and the file is shared by the users. Further, document data which is placed in a groupware such as Lotus Notes (registered trademark) or such, is shared by the users.

One purpose of sharing a document by a plurality of users is circulation of the document among the users. In the case, the document is circulated among the relevant persons, arguments or modifications for the contents of the document are given by the relevant persons, and a creator modifies the document in a final version as is necessary. Also in this case, transmission of electronic mails may be carried out widely. However, in this case, the creator receives modified versions of the document from the relevant persons respectively, checks the modified versions of the document one by one, and reflects the thus-obtained modifying points on the own original document.

In order to achieve more effective document circulation, in one method, a document may be placed in a groupware or a Web server, a pointer indicating the document is delivered to relevant persons, and the document on the server is directly modified or edited by the relevant persons.

However, in this method, the relevant persons may modify or edit the same document on the server simultaneously, and thus, conflicts may occur. Further, because modification, editing or giving comments is carried out by many users simultaneously, it is necessary for a document creator to view the entire document to determine how to actually modify the original document.

Further, when a document is shared by a plurality of users, a document created by another person is read or re-used, in many cases. For example, a way of sharing information called ‘social bookmark’ may be used for the purpose.

Generally speaking, bookmark is used for such a situation that a user stores in his or her computer a URL (Uniform Resource Locator) of a Web page which the user has read with the use of a Web browser with bookmark, and the user can call and read the same Web page easily with the use of the bookmark. The bookmark is used in such a way that corresponding information is stored in a tree structure in many cases.

The above-mentioned social bookmark is such a version of the bookmark that the bookmark is stored in one place in a communication network and is shared by many users.

In an information sharing way with the use of the social bookmark, generally speaking, each user gives a short text or comments called a tag to information, and, with the use of the given tag, each user can access the information from various viewpoints such that:

A group of URLs associated by a specific tag is to be accessed;

A user who gives a group of tags or comments in association with a specific URL is to be identified; or

A user who gives a bookmark is to be identified.

Japanese Patent No. 3700733, for example, discloses such an art concerning the above-mentioned social bookmark.

Japanese Patent No. 3700733 discloses that comments or evaluation information given to a document managed as primary information are stored and managed in association with the document as secondary information. The managed secondary information is used in such a manner that, in a case where the comments or evaluation information have been given to the document, when the document is displayed in response to access to the primary information, existence of the comments or evaluation information is indicated, or the document may be extracted which is thus evaluated as being important. Thus, with the use of the secondary information, the document as the primary information is managed. Thus, convenience of the primary information improves by the secondary information.

As mentioned above, social bookmark provides a new function such that, with the use of the social bookmark, a document is managed with the use of information such as comments such as an evaluation, an argument, a modification, an annotation, or such (which are generically referred to as “comments” or a “comment”, hereinafter) given to the document. However, the following points may be considered.

A comment is given to the entirety of a resource (document) indicated by a URL, and, commonly, it is not indicated which particular document element of the document the comment has been given. Therefore, it is not possible for another user to understand which particular document element the comment has been given. Thus, convenience in using the information may not be sufficient.

A document to which bookmark is given may be deleted by a user. When the document is thus deleted, the bookmark is invalidated accordingly, and also, a comment which has been given to the document is deleted automatically.

### SUMMARY OF THE INVENTION

The present invention has been devised in consideration of these points in a case where a document is managed in such a manner that the document can be read by a plurality of users in a sharing manner, and comments may be given to the document by the plurality of users. An object of the present invention is to provide a configuration such that, even when an original document is deleted, comments which have been given to the document can be stored, and also, convenience in using the comments given to the document can be improved as a result of a relation of the comments to a document element of the document to which the comments have been given being indicated.

According to the present invention, a document is stored in a document element storage part for each document element of the document, a comment given to the document element is input, and the comment is stored in a comment storage part in such a manner that the comment can be identified as the comment which is associated with the document element.

Other objects, features and advantages of the present invention will become more apparent from the following detailed description when read in conjunction with the accompanying drawings.

### BRIEF DESCRIPTION OF THE DRAWINGS

FIG. 1, (A) shows an example of a document illustrating a concept of a document element, and (B) shows a table in which document elements and annotations are associated with each other;

FIG. 2 shows a general configuration of one example of an image processing apparatus in one embodiment provided in a communication network;

FIG. 3 shows a block diagram of one example of a document annotation management system provided in a document element management server;

FIG. 4 shows a flow chart of a process for registering a document in a DB included in the document annotation management system shown in FIG. 3;

FIG. 5 shows a flow chart of a process for extracting a document element and/or an annotation registered in the DB included in the document annotation management system shown in FIG. 3;

FIG. 6 shows a configuration of a computer which may be used for establishing the document annotation management system;

FIG. 7A shows a flow chart of a process for extracting annotations given to a document element from the DB included in the document annotation management system shown in FIG. 3;

FIG. 7B shows a flow chart of a process for extracting only document elements to which annotations have been given from the DB included in the document annotation management system shown in FIG. 3;

FIG. 7C shows a flow chart of a process for extracting annotations including a specific keyword from the DB included in the document annotation management system shown in FIG. 3; and

FIG. 8, (A) shows an actual example of a document element management table (document element storage part) stored in a document element DB part and (B) shows an actual example of an annotation management table (comment storage part) stored in a document annotation DB part.

### DESCRIPTION OF REFERENCE NUMERALS

100 Client Computer

200 Document Element Management Server (s1)

210 Document Annotation Management System

230 Document Analyzing Part

235 Document Element Database Part

240 Data (Document Element or Annotation) Extracting Part

245 Document Annotation Database Part

300 Document Management Server (w1)

400 Document Management Server (w2)

### DETAILED DESCRIPTION OF THE PREFERRED EMBODIMENTS

In an embodiment, an information processing apparatus includes a document element storing part configured to store a document in a document element storage part for each document element of the document, a comment input part configured to input a comment corresponding to the document element to a comment storing part, and the comment storing part configured to store the comment, which has been input by the comment input part for the document element in a comment storage part in such a manner that the comment can be identified as the comment which is associated with the document element.

In the embodiment, the information processing apparatus may further include an information extracting part configured to respond to an extraction request to extract a document element or a comment from the document element storage part or the comment storage part.

In the embodiment, the information extracting part may respond to a collective extraction request for comments designating a document element, to extract comments associated with the designated document element from the comment storage part.

In the embodiment, the information extracting part may respond to an extraction request for document elements to which comments have been input, to extract the comments from the comment storage part, and also, extract the document elements to which the comments have been input from the document element storage part.

In the embodiment, the information extracting part may respond to an extraction request for document elements designating a keyword, to extract comments including the keyword from the comment storage part, and also, extract document elements to which the comments have been input from the document element storage part.

The embodiment may further include a document analyzing part configured to analyze a document to draw a document element from the document, wherein the document element storing part stores the document element drawn by the document analyzing part in the document element storage part.

In another embodiment, a computer readable information recording medium tangibly embodying an information processing program which, when executed by a computer processor, performs an information processing method used by an information processing apparatus, the method comprising the steps of a document element storing step of storing a document in a document element storage part for each document element of the document, a comment input step of inputting a comment corresponding to the document element, and a comment storing step of storing the comment, which has been input in the comment input step for the document element, in a comment storage part in such a manner that the comment can be identified as the comment which is associated with the document element.

The method may further include an information extracting step of responding to an extraction request to extract a document element or a comment from the document element storage part or the comment storage part.

In the embodiment, the information extracting step may be carried out in response to a collective extraction request for comments designating a document element, to extract comments associated with the designated document element from the comment storage part.

In the embodiment, the information extracting step may be carried out in response to an extraction request for document elements to which comments have been input, to extract the comments from the comment storage part, and also, extract the document elements to which the comments have been input from the document element storage part.

In the embodiment, the information extracting step may be carried out in response to an extraction request for document elements designating a keyword, to extract comments including the keyword from the comment storage part, and also, extract document elements to which the comments have been input from the document element storage part.

The method may further include a document analyzing step of analyzing a document to draw a document element from the document, wherein, in the document element storing step, the document element drawn in the document analyzing step is stored in the document element storage part.

In the above-mentioned embodiments, from a document, a document element in a form of an image expression element is drawn, and corresponding information is managed and processed in such a manner that, a comment may be given to each document element, and the comment may be displayed together with the corresponding document element. As a result, in a case where a plurality of users share a document, a document element for which a comment has been given can be clearly indicated, and thus, convenience to use the comment can be improved. Further, document elements and comments associated with the document elements are stored separately from an original document, and thereby, it is possible to prevent deletion of the original document from influencing the corresponding document elements and comments associated with the document elements, and thus, it is possible to avoid a loss of information.

An image processing apparatus in one embodiment will now be described in detail with reference to figures.

The image processing apparatus has such functions that, image expression elements are drawn as document elements from a document which a plurality of uses cab read in a sharing manner, a comment (in the embodiment, an annotation) is given to a document element thus drawn from the document, and the document elements and the corresponding annotations associated with the document elements are stored and managed separately from the document. It is noted that, the comment given to the document element is not limited to an annotation, and, as mentioned above, various contents such as an evaluation, an argument, a modification, and so forth, may be given to document elements.

In the related art, as mentioned above, evaluation information is given to the entirety of a resource (document), and thus, it is not indicated which part of the resource the evaluation information has been given. Thus, convenience to use the evaluation information may not be sufficient. In contrast thereto, in the embodiment, a document is decomposed into document elements, and an annotation can be given to a unit of a document element thus obtained from the decomposition.

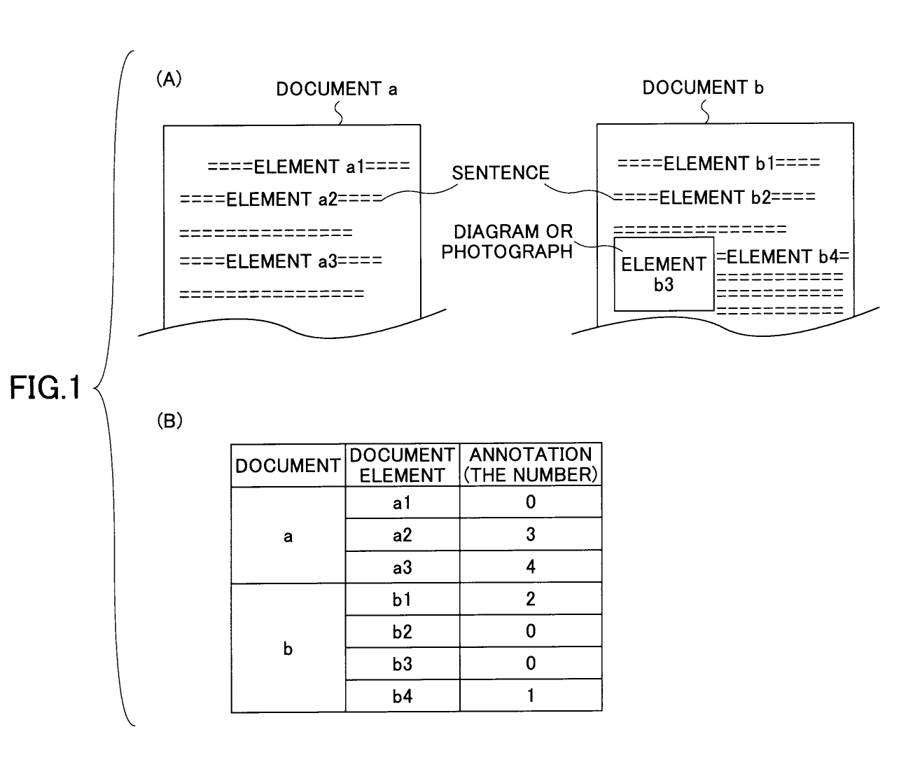

The document element is a unit which a user reads when the user gives an annotation thereto. In consideration of user interface, it is preferable that, when a corresponding document is displayed on a screen of a display device, or when the document is printed out, corresponding things can be designated by a user. In an example of FIG. 1, (A), elements a1, a2, a3, b1, b2, b3 and b4 may be used as document elements, respectively.

Therefore, as shown in the example of a document shown in FIG. 1, (A), when a document ‘a’ or a document ‘b’ is expressed as a page image, document elements are drawn as partial elements having meanings from the page image of the document. For example, the following things may be suitably drawn as document elements:

When a document includes a plurality of paragraphs or sentences each having a plurality of lines, lines or paragraphs or sentences (such as, in FIG. 1, (A), elements a1, a2, a3, b1, b2, b4) may be drawn as document elements.

Areas of charts/diagrams, or photographs (such as, in FIG. 1, (A), element b3) may be drawn as document elements.

Sentences or such included in an area defined by dividing lines or such may be drawn as a document element.

One advantage of such a method of analyzing a document in which image expression elements are processed is that, it is possible to use any analyzing method without depending on a particular electronic format of the document.

Thus, a document element is defined as an area in a page in which a document is expressed as an image, and then, is specified and managed as an identifier (referred to as an ID, hereinafter) is attached to each document element.

For example, an ID of a document element is, as shown in a table shown in FIG. 1, (B), IDs such as a1, a2, a3, which are consecutive numbers, are given, and corresponding document elements are managed. It is noted that, in the table shown in FIG. 1, (B), data concerning annotations, which will be described later, is associated to correspond to the document elements a1, a2 and a3, respectively.

According to the above-mentioned method in which image expression elements are processed, document elements are drawn from a document, annotations are given to the thus-drawn document elements, and the document elements are used in managing the document.

When managing the document in the image processing apparatus in the embodiment, an annotation given to a document element is stored and managed separately from an original document, where the document and the document element are both associated with the annotation. This management method is advantageous in that, even when the original document is deleted, an annotation given to the document is left without being deleted. Thus, deletion of the original document does not affect an annotation given to a document element of the deleted original document, and the annotation given to the document element is kept without being deleted.

In the embodiment, a database (simply abbreviated as a DB, hereinafter) for document elements and a DB for annotations are provided separately from a DB for original documents. With the use of these DBs, document elements and annotations associated with document elements are managed.

The image processing apparatus in the embodiment may be provided in such a manner that, a document is stored in a memory of a computer acting as the image processing apparatus, and the computer itself is used to carry out an image processing function. However, actually, in the embodiment described below, the image processing apparatus is connected to a client and server system in a communication network.

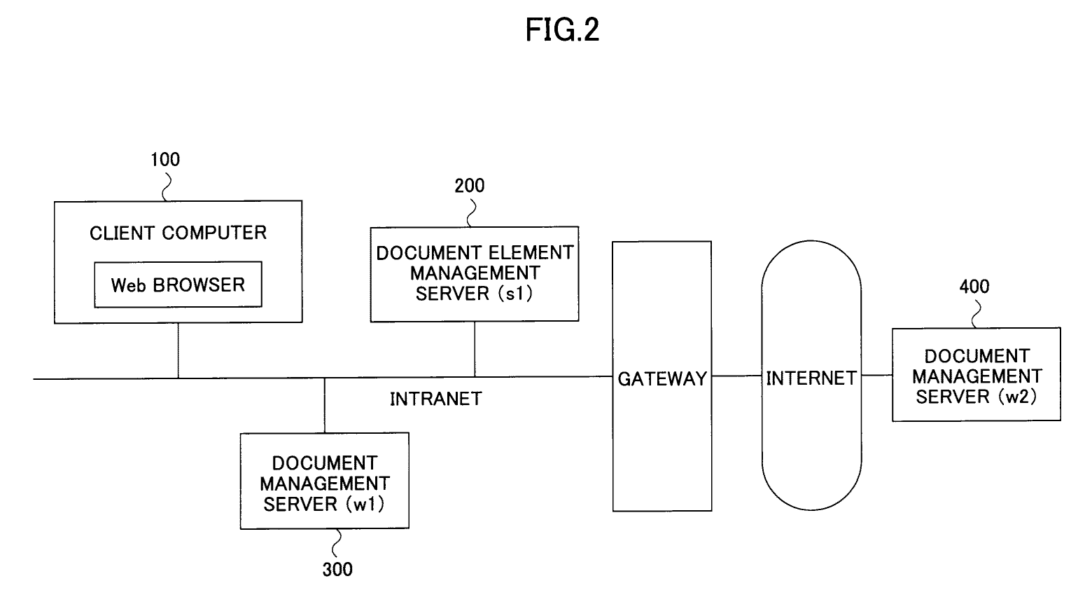

FIG. 2 generally shows one example of the image processing apparatus in the embodiment connected to the client and server system in the communication network. The image processing apparatus will now be described with reference to FIG. 2.

In FIG. 2, in the communication network, an intranet and the Internet are connected by means of a gateway. In the intranet, a client computer 100 and a document management server (w1) 300 storing documents are connected. In the Internet, a document management server (w2) 400 storing documents are connected. Therewith, the client and server system in a well-known art is provided.

Further, to the intranet, a document element management server (s1) 200 is connected. This server (s1) 200 has an image processing function to store and manage annotations associated with document elements. It is noted that, the client computer 100 is such that, a Web browser operates in the computer 100, and it is possible to call an operation page for controlling the document element management server (s1) 200.

Next, a configuration and an operation of the document element management server (s1) 200 will be described.

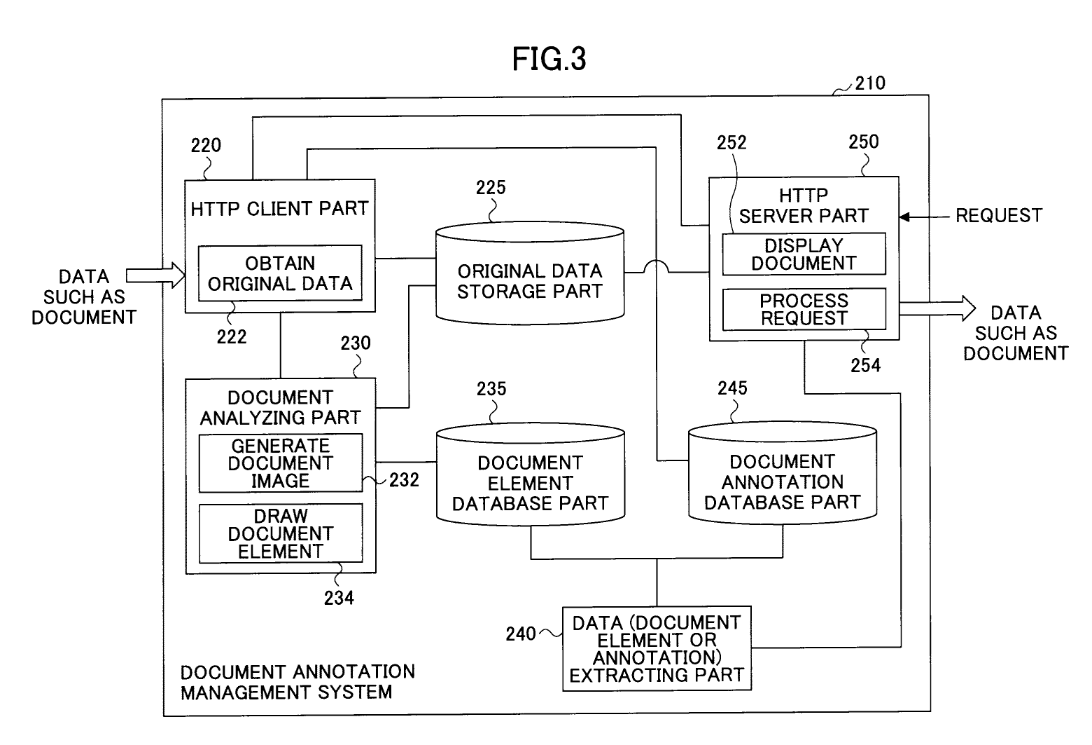

In response to a request from the client computer 100, the document element management server (s1) 200 draws a document element from a designated document, carries out a process for giving an annotation to the document element, manages the document element and the annotation given to the document element in the respective DBs. Further, the document element management server (s1) 200 extracts the document element and/or the annotation managed in the respective DBs, in response to a corresponding request from the client computer 100, and provides the extracted document element and/or annotation to the client computer 100. The document element management server (s1) 200 has functional parts as its components for carrying out these processes, respectively. FIG. 3 shows a general block diagram of a document annotation management system 210 provided in the document element management server (s1) 200. The document annotation management system 210 has the above-mentioned functional parts as will be described now.

The document annotation management system 210 has, as shown in FIG. 3, an HTTP (Hyper Text Transfer Protocol) client part 220, an HTTP server part 250, a document analyzing part 230, an original data storage part 225, a document element DB part 235, a document annotation DB part 245, and a data (i.e., a document element or an annotation) extracting part 240.

The HTTP client part 220 responds to a request from the client computer 100, to read document data from the document management server (w1) 300 or the document management server (w2) 400 which stores the document data having URLs designated by the client computer 100. The document annotation management system 210 treats the read document data as original document data. The read original document data is obtained by an original data obtaining part 222 included in the HTTP client part 220. From the original data obtaining part 222, the original document data is transferred to an original data storage part 225. Then, the original document data is managed by the original data storage part 225. Further, the original document data is analyzed by the document analyzing part 230, which will be described later.

The HTTP server part 250 has a request processing part 254 processing requests given by the client computer 100 and a document display part 252. In the document annotation management system 210, the request processing part 254 receives a request given by the client computer 100 as a result of a user operating the above-mentioned Web browser. The document display part 252 outputs data in response to a corresponding request from the client computer 100 for displaying components on the client computer 100 such as a document, a document element, an annotation, an operation page, and so forth.

The original data storage part 225 manages the original document data obtained by the HTTP client part 220, and document images created by a document image generating part 232 of the document analyzing part 230.

The document element DB part 235 stores and manages document elements drawn by the document analyzing part 230 with IDs given thereto.

The document annotation DB part 245 stores and manages annotations given to document elements where the annotations are associated with the corresponding IDs of the document elements. The annotations may be data input to the client computer 100 by the user as the user operates the Web browser, or data which the document annotation management system 210 automatically gives. Data of the annotations may be preferably data, which can be expressed as images, such as text, pictures or such.

The document analyzing part 230 has the document image generating part 232 and a document element drawing part 234 for the purpose of analyzing a document stored in the original data storage part 225, and drawing document elements from the document.

When a given document is not data in a form of images, the document image generating part 232 converts the given document in such a form that the document can be used to be displayed on a display device or printed out. That is, the document image generating part 232 converts the given document into data in an image expression form (i.e., the above-mentioned image expression elements) such that an area dividing process, which will be described later, can be carried out on the data. Such a process of converting the given document into data in an image expression form may be a process in which the given document is read by means of a corresponding application, and the given document is obtained as images with the use of a function which is unique to the application, or a process in which the given document is obtained as images as a result of the given document being printed out. For example, it is possible to generate images having a snapshot of a displayed page, with a support of canvas in FireFox (registered trademark) of the Mozilla Foundation company, version 2.0, which is an open source Web browser. Further, when output in the PostScript (registered trademark) format from the application is available, a printed image can be obtained with the use of such a tool that image data of each page can be generated from a PDF image. As such a tool, PostScript which is an open resource, or GhostScript which is included in a PDF family, may be used.

The document element drawing part 234 is used to draw a document element from a document in an image expression form. Various methods have been proposed to carry out the above-mentioned area dividing process for dividing document elements from given document images (i.e., a document in an image expression form) to draw the document elements from the document. Any one of these methods may be used in the embodiment. For example, from a document expressed in digital images, diagram/photograph areas and text areas are divided. Then, for the text areas, such an area dividing technique that character lines on which an OCR (Optical Character Reader) can be used are recognized can be used. Japanese Laid-Open Patent Application No. 2001-297303 discloses the technique, for example.

In the embodiment, document elements included in a document are identified and annotations may be given thereto. In the embodiment, a configuration may be provided such that only document elements classified into a specific type are treated as targets to which annotations are given. For example, paragraphs, diagrams, photographs or such may be treated as targets to which annotations can be given. However, horizontal lines used as separators to divide into areas may not be treated as targets to which annotations can be given.

In information of a document element thus drawn from a document, information indicating a position of an area of the document element in the document in an image expression form, and image data of the document element itself are included. When the document element includes character/letter information, the character/letter information is also included in the above-mentioned information of the document element. The information of document elements is managed by the document element DB part 235.

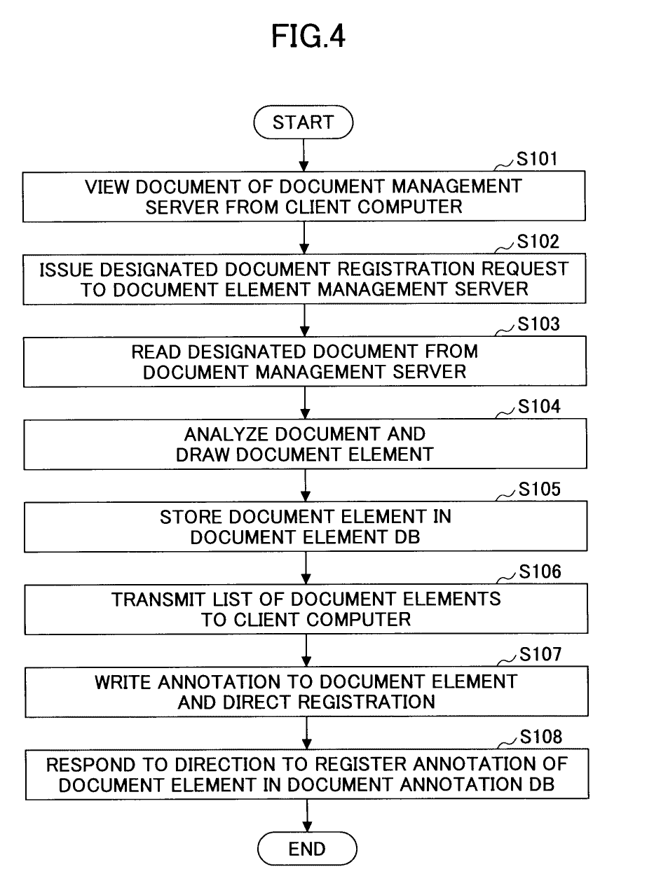

Further, in the embodiment, the information of document elements stored in the document element DB part 235 can be extracted in response to a request given by the client computer 100 in units of document elements. Further, in a registering process which will be described later (FIG. 4), an annotation can be given to each document element drawn from a document, and the given annotation is managed by the document annotation DB part 245, in association with the corresponding document element.

Therefore, an ID is given to each document element, and the document element is managed by the document element DB part 235. As a result, for example, as (Example 2) shown below, a document element may be identified with the use of a URL. It is noted that, in the embodiment, also to an original document obtained by the HTTP client part 220, an ID is given as (Example 1) shown below, because the original document is to be managed by the original data storage part 225.

### EXAMPLE 1

### A document has an ID number of 12345, and is identified by a URL, i.e., http://s1.example.com/docs/12345

### EXAMPLE 2

### A document element, which is 20-th from the top of those belonging to the document of the ID number of 12345, is identified by a URL, i.e., http://s1.example.com/docs/12345/20

The data extracting part 240 shown in FIG. 3 responds to a request given by the client computer 100 and received by the HTTP server part 250, to extract an annotation and/or a document element from the document annotation DB part 245 and/or the document element DB part 235, respectively, according to corresponding extracting requirements of the given request, and then, transfers the extracted annotation and/or document element to the document display part 252 of the HTTP server part 250.

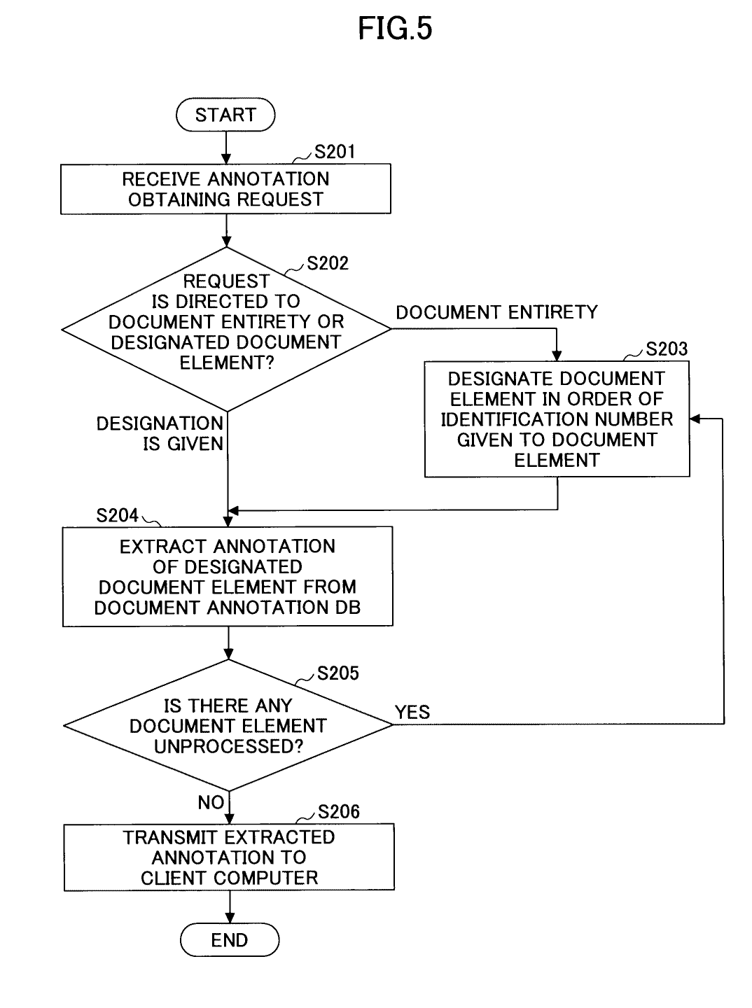

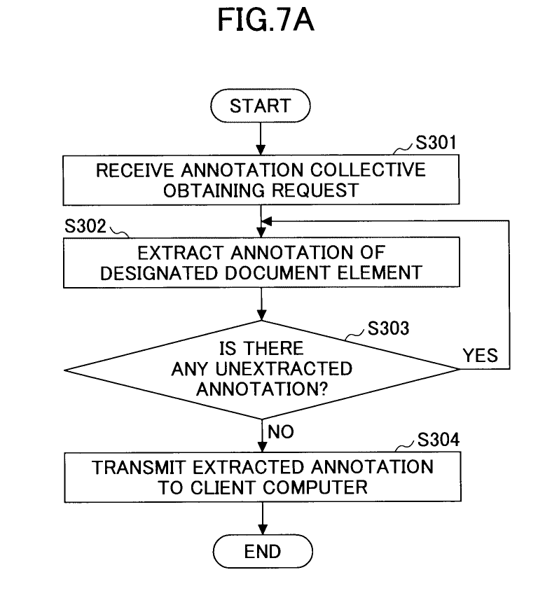

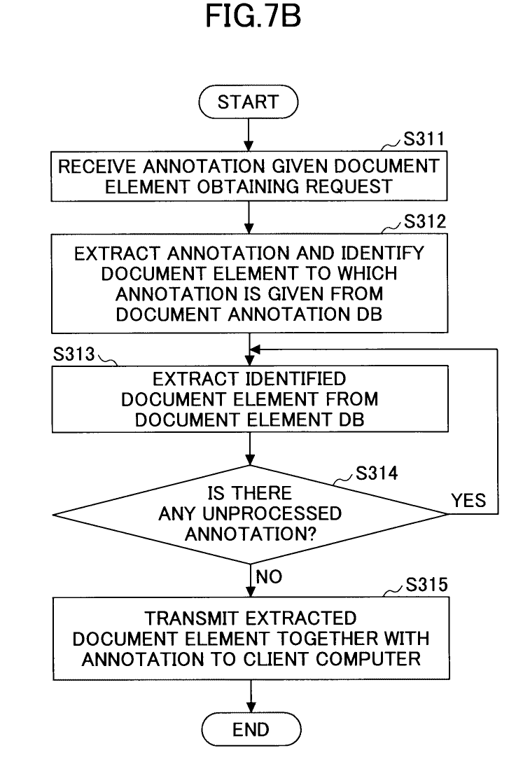

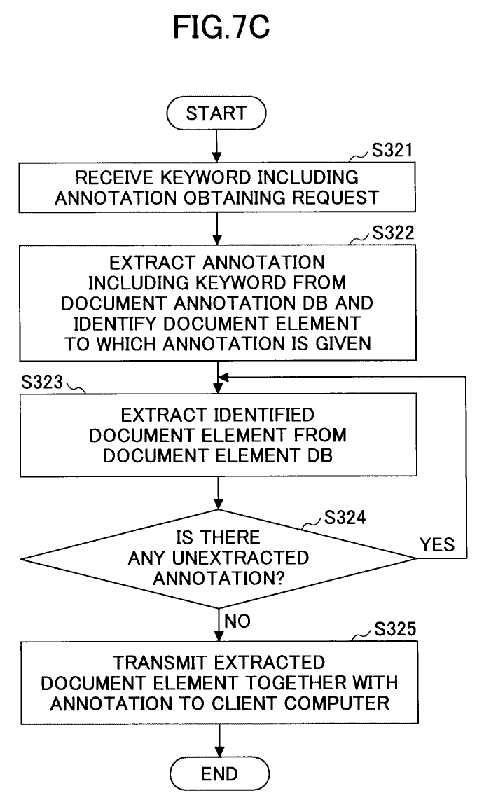

Further, the above-mentioned extracting requirements of the request given by the client computer 100 can be set by a user with the use of the above-mentioned Web browser of the client computer 100 in an annotation obtaining process described later (FIG. 5, as well as FIGS. 7A, 7B and 7C).

As the above-mentioned extracting requirements, for example, following types (1) through (3) may be used.

(1) Extracting annotations given to a single document element:

For example, in the example of a document shown in FIG. 1, (A), the document ‘a’ is divided into three document elements a1, a2 and a3. As shown in FIG. 1, (B), no annotations have been given to the document element a1. Three annotations have been given to the document element a2. Four annotations have been given to the document element a3. Then, as the extracting requirements, only a single document element, i.e., the document element a2, for example, is designated. Thereby, the three annotations given to the designed document element a2 are extracted. With the use of the type of extracting requirements, it is possible to extract only annotations concerning a specific document element. Therefore, it is possible to easily collect annotations narrowing down to the specific document element. FIG. 7A shows a flow of a process according to the type of extracting requirements.

In FIG. 7A, in step S301, when a request for obtaining annotations given to a single document element is transmitted via the request processing part 254 of the HTTP server part 250 from the client computer 100, the data extracting part 240 of the document element management server (s1) 200 extracts an annotation given to the single document element from the document annotation DB part 245 in step S302. Next, the data extracting part 240 of the document element management server (s1) 200 determines in step S303 whether all the annotations given to the single document element have been extracted. When it is determined in step S303 that all the annotations given to the single document element have been extracted (YES), the extracted annotations are transmitted to the client computer 100 via the request processing part 254 of the HTTP server part 250. On the other hand, when it is determined in step S303 that all the annotations given to the single document element have not been extracted yet (NO), the above-mentioned step S302 is repeated until a determination of step S303 becomes YES.

(2) Extracting only document elements to which annotations have been given:

For example, the document ‘b’ shown in FIG. 1, (A) is treated as a target and the type of extracting requirements is used. As shown in FIG. 1, (B), two annotations have been given to the document element b1. No annotation has been given to the document element b2. No annotation has been given to the document element b3. One annotation has been given to the document element b4. Therefore, with the use of the type of extracting requirements, only the document elements b1 and b4 to which the annotations given are extracted. With the use of the type of extracting requirements, it is possible to rapidly understand modifying points, for example, when the document ‘b’ has been reviewed by a plurality of users, and modifying points have been given as a result as annotations. FIG. 7B shows a flow of a process according to the type of extracting requirements.

In FIG. 7B, in step S311, when a request for obtaining only document elements to which annotations have been given is transmitted via the request processing part 254 of the HTTP server part 250 from the client computer 100, the data extracting part 240 of the document element management server (s1) 200 extracts annotations from the document annotation DB part 245, and also, identifies document elements to which the annotations have been given, in step S312. Next, the data extracting part 240 of the document element management server (s1) 200 extracts the thus-identified document elements from the document element DB part 235 in step S313. Next, the data extracting part 240 of the document element management server (s1) 200 determines in step S314 whether all the annotations stored in the document annotation DB part 245 have been processed. When it is determined in step S314 that all the annotations stored in the document annotation DB part 245 have been processed (YES), the extracted document elements, together with the extracted annotations, are transmitted to the client computer 100 via the request processing part 254 of the HTTP server part 250, in step S315. On the other hand, when it is determined in step S314 that all the annotations stored in the document annotation DB part 245 have not been processed yet (NO), the above-mentioned steps S312 and S313 are repeated until a determination of step S314 becomes YES.

(3) Extracting annotations including a specific keyword:

For example, the document ‘a’ and the document ‘b’ shown in FIG. 1, (A) are treated as targets, and the type of extracting requirements are used. As shown in FIG. 1, (B), the three annotations have been given to the document element a2, the four annotations have been given to the document element a3, the two annotations have been given to the document element b1, and the one annotation has been given to the document element b4. Therefore, from these annotations given to the document elements, only annotations including a specific keyword are extracted. By using the type of extracting requirements, convenience in using annotations can be improved. Further, as ‘tagging’ in the above-mentioned social bookmark, it is possible to define a collection of document elements, collected in a user's unique view point. FIG. 7C shows a flow of a process according to the type of extracting requirements.

In FIG. 7C, in step S321, when a request for obtaining annotations including a specific keyword is transmitted via the request processing part 254 of the HTTP server part 250 from the client computer 100, the data extracting part 240 of the document element management server (s1) 200 extracts annotations including the specific keyword from the document annotation DB part 245, and also, identifies document elements to which the annotations have been given, in step S322. Next, the data extracting part 240 of the document element management server (s1) 200 extracts the thus-identified document elements from the document element DB part 235 in step S323. Next, the data extracting part 240 of the document element management server (s1) 200 determines in step S324 whether all the annotations stored in the document annotation DB part 245 and including the specific keyword have been processed. When it is determined in step S314 that all the annotations stored in the document annotation DB part 245 and including the specific keyword have been processed (YES), the extracted document elements, together with the extracted annotations, are transmitted to the client computer 100 via the request processing part 254 of the HTTP server part 250, in step S325. On the other hand, when it is determined in step S324 that all the annotations stored in the document annotation DB part 245 and including the specific keyword have not been processed yet (NO), the above-mentioned steps S322 and S323 are repeated until a determination of step S324 becomes YES.

In order to carry out the process of extracting annotations and/or document elements in response to any one of the above-mentioned types (1) through (3), the data extracting part 240, as well as the table shown in FIG. 1, (B) or such, may be provided so that the process can be carried out efficiently.

Next, with reference to FIG. 4, i.e., a flow chart of a process of registering documents, document elements and annotations in the respective DBs for documents stored in the document management server (w1) 300 or the document management server (w2) 400, will be described. The process is carried out by the document annotation management system 210 shown in FIG. 3.

First, a user calls a page for reading a document stored in the document management server (w1) 300 or the document management server (w2) 400 on a display device of the client computer 100, for the purpose of reading a document. Then, from the page for reading a document, the user designates a document to read, and reads the document (in step S101). Data of the document thus designated from the page for reading a document is transmitted from the document management server (w1) 300 or the document management server (w2) 400, and then, the user can read the document from the client computer 100.

Next, the user starts up bookmarklet, which will be described below, for the purpose of registering the document in the document annotation management system 210 of the document element management server (s1) 200. Then, the user issues a registering request for the document from the bookmarklet (in step S101).

The above-mentioned bookmarklet is a small program written in script language, and is used for carrying out an appropriate process according to a state of the Web browser. In the embodiment, the bookmarklet configured for registering issues a request for calling a URL such as that shown below (i.e., (Example of URL)), and displays a page for registering from the document element management server (s1) 200 on the Web browser of the client computer 100.

### Example of URL

http://s1.example.com/api/register?url=http://w1.example.com/doc/my/review/132

It is noted that, in the above-mentioned URL, “s1” indicates the document element management server (s1), and “w1” indicates the document management server (w1).

The request processing part 254 of the document annotation management system 210 responds to the above-mentioned registering request for the document, to direct the HTTP client part 220 to read the document designated by a parameter “url=” included in the above-mentioned (Example of URL) from the document management server (w1) 300 or the document management server (w2) 400. The HTTP client part 220 responds to the direction, to read the designated document accordingly (in step S103). The thus-read document is then stored in the original data storage part 225.

Next, the document thus read by the HTTP client part 220 is then transfer to the document analyzing part 230, and the document analyzing part 230 draws document elements from the document (in step S104). At this time, when the document thus read by the HTTP client part 220 is not document images in the above-mentioned image expression form, the document image generating part 232 converts the document into document images for respective pages of the document. The thus-obtained document images undergo the above-mentioned area dividing process, and document elements obtained from the area dividing process are drawn by the document element drawing part 234.

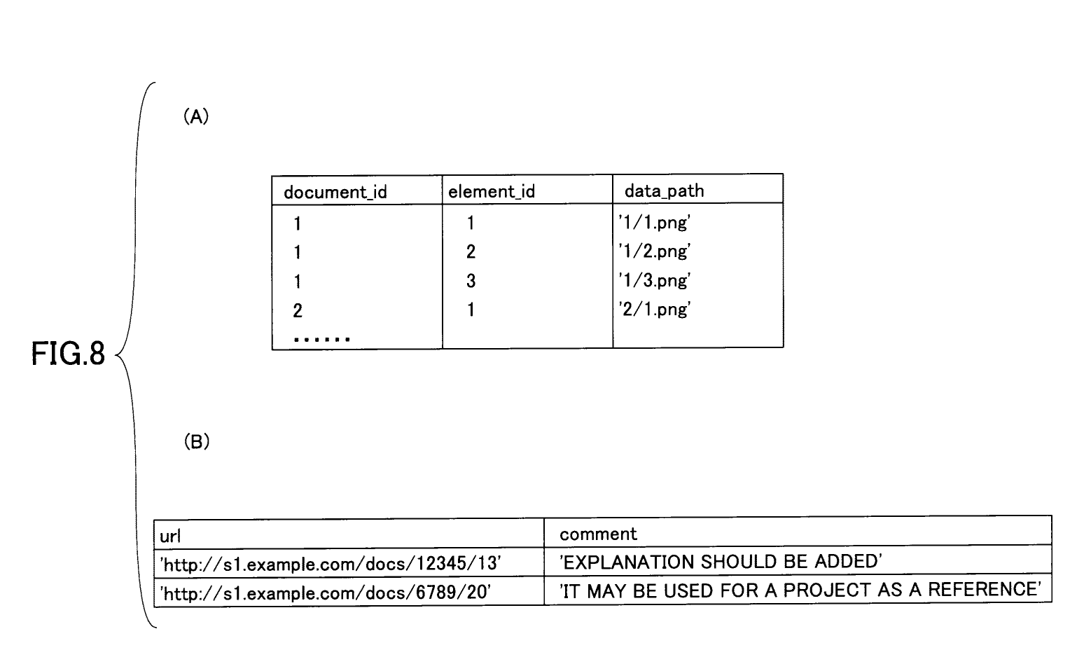

Further, the document analyzing part 230 gives consecutive numbers as IDs to the drawn document elements, respectively, and registers the document elements in a table (described later with reference to FIG. 8, (A)) of the document element DB part 235 (in step S105).

After that, the request processing part 254 of the HTTP server 250 reads the above-mentioned table, and transmits data of HTML (Hyper Text Markup Language) for displaying a list of the document elements to the Web browser of the client computer 100 which has issued the corresponding registering request for the document (in step S106).

Then, the user can see the list of the document elements displayed on the display device of the client computer 100 from the transmitted data of HTML. The user may select one of the document elements included in the list, and write an annotation for the selected document element. Then, when the user presses a ‘registering button’ also displayed on the display device of the client computer 100, a direction for the thus-written annotation to be actually registered for the document element is generated (in step S107).

Then, in response to the generated direction, which is transmitted from the client computer 100 together with the ID of the document element to which the annotation has been given and the given annotation, the HTTP client part 220 of the document annotation management system 210 registers all the document elements included in the list, in the document element DB part 235. Further, the HTTP client part 220 of the document annotation management system 210 registers the annotation in the document annotation DB part 245 in association with the consecutive number as ID of the corresponding document element (in step S108).

After registering of the annotation is finished, the process of FIG. 4 is finished.

Next, a process of extracting data of a document element and/or an annotation thus registered in the document element DB part 235 and/or the document annotation DB part 245 in response to a request given by the client computer 100, and transmitting the data to the client computer 100, will be described in detail. The process is carried out by the document annotation management system 210, provided in the document element management server (s1) 200, shown in FIG. 3.

The process of extracting a document element and/or an annotation given to a document or a document element is carried out with the use of a Get request directed to a URL corresponding to the document element and/or the annotation, in the embodiment.

For example, an annotation given to a document having a document ID, 12345, and a document element number, 20, is obtained with the use of a Get request for calling a URL such as that shown as (Example of URL) below. It is noted that, in (Example of URL) below, an annotation is indicated as “comments”. This type of request corresponding to the above-mentioned type (1) described above with reference to FIG. 7A.

### Example of URL

http://s1.example.com/comments/docs/12345/20

A response to the above-mentioned Get request is returned in a form of data of XML (extensible Markup Language), such as that shown in (Example of XML) below, for example.

### Example of XML

```
    <?xml version=”1.0” encoding=”utf-8”>
    <commentList
about=”http://s1.example.com/docs/12345/20”>
    <comment>comment 1</comment>
    <comment>comment 2</comment>
    </commentList>
```

The Web browser of the client computer 100 receives the data of XML, and converts the data of XML with the use of ECMA (European Computer Manufacturing Association) Script or XSLT (XML Stylesheet Language Transformations) into a form such that the data can be displayed on the screen of the display device.

Further, all the annotations given to the document of the document ID, 12345 can be obtained with the use of a Get request for calling a URL such as that shown in (Example of URL) below.

### Example of URL

http://s1.example.com/comments/docs/12345

A response to the Get request is returned in a form of data of XML such as that shown in (Example of XML) below.

### Example of XML

```
    <?xml version=”1.0” encoding=”utf-8”>
    <commentList
about=”http://s1.example.com/comments/docs/12345”>
    <comment
about=”http://s1.example.com/docs/12345/20”>comment
1</comment>
    <comment
about=”http://s1.example.com/docs/12345/20”>comment
2</comment>
    </commentList>
```

Further, when a Get request for calling a URL such as that shown in (Example of URL) below, only document elements having annotations including a character string “WORD” (i.e., a specific keyword) are extracted and output. This type of request corresponding to the above-mentioned type (3) described above with reference to FIG. 7C.

### Example of URL

http://s1.example.com/comments/docs?query=WORD

The above-described operation of the document annotation management system 210 shown in FIG. 3 provided in the document element management server (s1) 200 to respond to a request given by the client computer 100, to extract and transmit a document element and/or an annotation will be described with reference to FIG. 5.

The document annotation management system 210 first receives a request issued by a user via the Web browser of the client computer 100 for obtaining a document element and/or an annotation (in step S201). The request is actually a Get request such as that mentioned above, and is issued to designate a URL corresponding to a document or a document element, as mentioned above.

Next, the request processing part 254 of the HTTP server part 250 determines, from the URL thus received in a form of a Get request, whether a target of the request is the entirety of a document or a specific document element (actually, a corresponding ID thereof) is designated (step S202).

As a result of the determination of step S202, when a specific document element is designated in the Get request (DESIGNATION IS GIVEN), the data extracting part 240 searches the document annotation DB part 245 for annotations stored in association with the above-mentioned ID of the specific document element, and extracts data of the annotations from the document annotation DB part 245 (in step S204).

On the other hand, when a result of the determination of step S202 is that the entirety of a document is designated as a target (DOCUMENT ENTIRETY), the data extracting part 240 designates document elements included in the designated document in order of the corresponding consecutive numbers which have been given to the respective document elements as IDs when the document elements have been drawn from the document (in step S203), and extracts annotations stored in the document annotation DB part 245 which have been stored in association with these IDs (step S204). After extracting the annotations of the designated document elements in step S204, the data extracting part 240 determines in step S205 whether or not there are still document elements of the target document which have not been processed yet. When there are still document elements of the target document which have not been processed yet (YES in step S205), a designation process in step S203 is carried out again, and steps S203, S204 and S205 are repeated until all the document elements included in the entirety of the document have been processed. It is noted that, in the embodiment, the document elements designated by the Get request or designated in step S203 may also be extracted from the document element DB part 235, together with the anotaions of these document elements extracted from the document annotation DB 245 in step S204.

When it has been determined that there are not document elements of the target document which have not been processed, and thus, extracting of data of the annotations or data of the annotations and the document elements has been completed (NO in step S205), the request processing part 254 of the HTTP server part 250 formats the extracted data of the annotations or data of the annotations and the document elements in a XML format as mentioned above, and transmits the formatted data to the client computer 100 as a response to the corresponding Get request.

Next, a method of displaying the data of the annotations or data of the annotations and the document elements, thus transmitted to the client computer 100, from the document annotation management system 210 in response to the corresponding Get request, will be described.

By using the document annotation management system 210, the user can carry out operation from the client computer 100 to input the above-mentioned Get request via the Web browser of the client computer 100 to obtain the data of the annotations or data of the annotations and the document elements, and, read a result of the extraction obtained in response to the above-mentioned Get request, displayed on the display device of the client computer 100 by a displaying function of the Web browser.

Thus, it is possible to give an instruction to the document annotation management system 210 via the Web browser of the client computer 100. Therefore, by using, from the document display part 252 which outputs pages for a user to carry out operation for inputting/outputting data, a page for directing a method for displaying the above-mentioned extraction result, i.e., data of a document, annotations and/or document elements, the user can select a specific method for displaying the extraction result, i.e., data of a document, annotations and/or document elements, in response to the user's operation.

The document display part 252 may first display a list of the extracted document elements and/or annotations given to the document elements on the display device of the client computer 100 as a page for the user to input a specific method for displaying the extraction result, after the data extracting part 240 extracts document elements and/or annotations in response to the above-mentioned Get request. Specifically, for example, at a first stage, only a list of the extracted document elements is displayed, and also, the number of annotations given to each of the document elements is displayed on one side of the document elements so that correspondence therebetween can be easily seen. Then, the user may place a pointer of a pointing device on the displayed page at a position at which a specific number of annotations is displayed, and carry out click operation. In response thereto, the corresponding annotations are displayed in a pop-up manner. Thereby, it is possible to simplify a display even when the number of extracted document elements or the number of extracted annotations is large.

Furthermore, for example, a configuration is provided such that when the user uses the pointing device to place the pointer at a displayed position of a specific document element and carries out clicking operation, a display may be switched into a page displaying the entirety of a document including the specific document element. It is noted that, an area corresponding to the specific document element in the document may be indicated by a broken line, and thus, the user can recognize a relationship between the document element and the entire document on the display device. As a result of a display being thus switched from the document element into the entire document to the user, the user can change a mode of display from a simple mode in which the document elements and annotations are displayed into a mode in which the user can also see the document surrounding the document element, and thus, the user can view various information in a natural way.

As mentioned above, the document annotation management system 210 which carries out the process of registering document elements of a given document and annotations described above with reference to FIG. 4 and the process of extracting the thus-registered document elements and/or annotations described above with reference to FIG. 5, as well as FIGS. 7A, 7B and 7C, can be provided in the document element management server (s1) 200 connected to the client and server network shown in FIG. 2 as in the embodiment as mentioned above. However, it is also possible provide a configuration in which the document annotation management system 210 is provided, not in such a manner of being connected to the client and sever system, but as an element of a single computer in a system for handling internal documents.

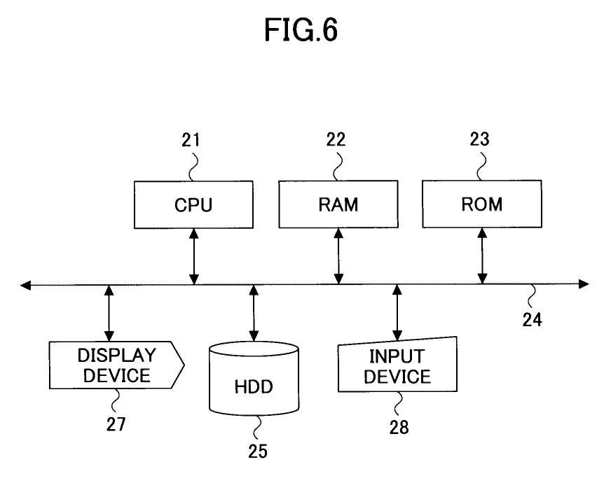

When the document annotation management system 210 is provided in any of these configurations, the document annotation management system 210 can be provided with the use of a general-purpose computer as hardware as shown in FIG. 6.

The computer shown in FIG. 6 includes a CPU 21 carrying out information processing operation and also carrying out overall control of respective parts of the computer, and respective memories of a RAM 22 and a ROM 23. Also, a hard disk drive (HDD) 25, a display device 27 and an input device 28 are connected via a bus, as shown in FIG. 6.

In the computer of FIG. 6, a program and data used for establishing the above-mentioned document annotation management system 210 are installed in the ROM 23 or the HDD 25. Then, the CPU 21 reads the program thus recorded in a computer readable information recording medium such as the ROM 23 or the HDD 25, and drives the program. Thus, the computer functions as the image processing apparatus in the embodiment.

FIG. 8, (A) shows an actual example of a document element management table as a document element storage part. The document element management table is stored in the document element DB part 235 shown in FIG. 3. FIG. 8, (B) shows an actual example of an annotation management table as a comment storage part. The annotation management table is stored in the document annotation DB part 245 shown in FIG. 3.

In FIG. 8, (A), as an item of document_id, document IDs given to respective documents are stored.

Further, as an item of element_id, document element IDs (i.e., the above-mentioned IDs of respective document elements) respectively given to the document elements are stored. In a case of this example, as mentioned above, consecutive numbers designated for a specific document are used as the document element IDs.

Further, as an item of data_path, path names in a file system used for storing images of respective document elements are stored. These paths are relative paths from a top directory set in the file system. The images of the document elements themselves are also stored in the document element DB part 235.

Next, an operation flow of taking a document element from a URL, as mentioned above, will be described in detail.

A flow from providing a request as a HTTP access from the client computer 100 to the document element management server (s1) 200, up to returning a corresponding document element to the client computer as a response to the request, is described now.

From the client computer 100, a Get access (i.e., providing the above-mentioned Get request) is carried out to the following URL, for example:

### Example of URL

http://s1.example.com/12345/13

The document element management server (s1) 200 responds to the Get access, reads a specific part of the URL, i.e., a latter part of the above-mentioned URL, and thus, takes the above-mentioned document ID “12345” and the document element ID “13”.

Next, the document element management server (s1) 200 reads the above-mentioned document element management table of FIG. 8, (A), to select from the document element management table a line satisfying the following requirements:

document_id=12345 AND element_id=13

Then, the document element management server (s1) 200 reads the item of data_path of the thus-selected line of the document element management table, to take a path name of the file system in which the document element designated by the above-mentioned URL is stored. Below, an example of description of instruction used in this case is shown:

### Example of Description of Instruction

SELECT data_path FROM document element management table
WHERE document_id=12345
AND element_id=13;

From the thus-taken path name, i.e., a data_path value (for example, $data_path) and a directory path (for example, DATA_DIR) for storing data unique to the file system, a position in the file system at which the image of the document element is stored is identified. Below, an example of a specific method of describing information identifying the position storing the image of the document element is shown:

### Example of a Specific Method of Describing Information Identifying the Position Storing the Image of the Document Element

DATA_DIR+“/”+$data_path

An actual description of the information identifying the position storing the image of the document element according to the above-mentioned specific method of describing is, for example, as shown below:

C: /data/12345/13.png

According to the description of information identifying the position storing the image of the document element, the document element management server (s1) 200 accesses data of the image of the document element in the document element DB part 235, and transmits the image of the document element to the client computer 100 as the HTTP response.

Next, a method of obtaining annotations given to a specific document is described in detail.

Here, as one example, an operation flow for taking all the annotations given to a specific document identified by the following URL is described.

### Example of URL

http://s1.example.com/docs/12345

The document management server (s1) 200 receives a designation of the above-mentioned URL, reads the above-mentioned annotation management table of FIG. 8, (B), and selects a line from the annotation management table beginning from the above-mentioned URL. Below, an example of description of an instruction for selecting a line beginning from the above-mentioned URL is shown:

### Example of Instruction

SELECT url, comment FROM annotation management table

### Where URL Like

‘http://s1.example.com/docs/12345/%’

The document element management server (s1) 200 transmits the contents of the comment item of the thus-selected line of the annotation management table, i.e., the contents of the annotation, to the client computer 100.

The present invention is not limited to the specifically disclosed embodiments, and variations and modifications may be made without departing from the scope of the present invention.

The present application is based on Japanese priority applications Nos. 2007-265655 and 2008-237138, filed Oct. 11, 2007 and Sep. 16, 2008, respectively, the entire contents of which are hereby incorporated herein by reference.

What is claimed is:

1. An information processing apparatus comprising:
a document element storing part configured to store a document in a document element storage part for each document element of the document;
a comment input part configured to input a comment corresponding to the document element to a comment storing part; and
the comment storing part configured to store the comment, which has been input by the comment input part for the document element in a comment storage part in such a manner that the comment can be identified as the comment which is associated with the document element.

2. The information processing apparatus as claimed in claim 1, further comprising:
an information extracting part configured to respond to an extraction request to extract a document element or a comment from the document element storage part or the comment storage part.

3. The information processing apparatus as claimed in claim 1, wherein:
the information extracting part responds to a collective extraction request for comments designating a document element, to extract comments associated with the designated document element from the comment storage part.

4. The information processing apparatus as claimed in claim 1, wherein:
the information extracting part responds to an extraction request for document elements to which comments have been input, to extract the comments from the comment storage part, and also, extract the document elements to which the comments have been input from the document element storage part.

5. The information processing apparatus as claimed in claim 1, wherein:
the information extracting part responds to an extraction request for document elements designating a keyword, to extract comments including the keyword from the comment storage part, and also, extract document elements to which the comments have been input from the document element storage part.

6. The information processing apparatus as claimed in claim 1, further comprising:
a document analyzing part configured to analyze a document to draw a document element from the document, wherein:
the document element storing part stores the document element drawn by the document analyzing part in the document element storage part.

7. A computer readable information recording medium tangibly embodying an information processing program which, when executed by a computer processor, performs an information processing method used by an information processing apparatus, the method comprising the steps of:
a document element storing step of storing a document in document element storage part for each document element of the document;
a comment input step of inputting a comment corresponding to the document element; and
a comment storing step of storing the comment, which has been input in the comment input step for the document element, in a comment storage part in such a manner that the comment can be identified as the comment which is associated with the document element.

8. The computer readable information recording medium as claimed in claim 7, the method further comprising:
an information extracting step of responding to an extraction request to extract a document element or a comment from the document element storage part or the comment storage part.

9. The computer readable information recording medium as claimed in claim 7, wherein:
the information extracting step is carried out in response to a collective extraction request for comments designating a document element, to extract comments associated with the designated document element from the comment storage part.

10. The computer readable information recording medium as claimed in claim 7, wherein:
the information extracting step is carried out in response to an extraction request for document elements to which comments have been input, to extract the comments from the comment storage part, and also, extract the document elements to which the comments have been input from the document element storage part.

11. The computer readable information recording medium as claimed in claim 7, wherein:
the information extracting step is carried out in response to an extraction request for document elements designating a keyword, to extract comments including the keyword from the comment storage part, and also, extract document elements to which the comments have been input from the document element storage part.

12. The computer readable information recording medium as claimed in claim 7, the method further comprising:
a document analyzing step of analyzing a document to draw a document element from the document, wherein:
in the document element storing step, the document element drawn in the document analyzing step is stored in the document element storage part.
